(19) United States
(12) Patent Application Publication
(10) Pub. No.: US 2006/0088346 A1
(43) Pub. Date: Apr. 27, 2006

(54) Floating stripper finger assembly and a fuser having same

(75) Inventor: Roger M. Swanson, Twin Leaf Terrace Webster, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/972,814

(22) Filed: Oct. 25, 2004

(51) Int. Cl. G03G 15/20

(52) U.S. Cl. 399/323

(57) ABSTRACT

A floating stripper finger assembly includes (a) a first baffle; (b) a second baffle, including a slot and a first anchor, and being spaced from, and with, the first baffle defining a media path therebetween; (c ) a stripper finger device having (i) a first end including a stripping tip for stripping media off of a media carrying member, (ii) a second end opposite the first end, (iii) a second anchor, and (iv) a trunnion for mounting movably within the slot in the second baffle; and (d) a resilient member connecting the first anchor to the second anchor for enabling the stripping tip and the trunnion to be movable in a floating manner between a first position and a second position relative to the media path, thereby preventing damage to the media carrying member.

The present disclosure relates to stripper fingers and associated mounts used with a fuser, such as for xerographic printers.

In xerographic or electrostatographic printers commonly in use today, a charge-retentive member is charged to a uniform potential and thereafter exposed to a light image of an original document to be reproduced. The exposure discharges the charge-retentive surface in exposed or background areas and creates an electrostatic latent image on the member, which corresponds to the image areas contained within the original document. Subsequently, the electrostatic latent image on the charge-retentive surface is made visible by developing the image with developing powder referred to in the art as toner. Most development systems employ a developer material that comprises both charged carrier particles and charged toner particles, which triboelectrically adhere to the carrier particles. During development the toner particles are attracted from the carrier particles by the charge pattern of the image areas on the charge-retentive area to form a powder image on the charge-retentive area.

This image is subsequently transferred to a sheet, such as copy paper, to which it is permanently affixed or fused by heating or by the application of pressure. Following transfer of the toner image to the sheet, the charge-retentive member is cleaned of any residual toner that may remain thereon in preparation for the next imaging cycle.

One approach to fixing or fusing the toner image is by applying heat and pressure while passing the sheet carrying the unfused toner images between a pair of opposed roller members at least one of which is internally heated. During this procedure, the temperature of the toner material is elevated to a temperature at which the toner material coalesces and becomes tacky. This heating causes the toner to flow to some extent into the fibers or pores of the sheet. Thereafter, as the toner material cools, solidification of the toner material causes the toner material to become bonded to the support member. Typical of such fusing devices are two roll systems wherein the fuser roll is coated with an adhesive material such as a silicone rubber or other low surface energy elastomers.

During the fusing process and despite the use of low surface energy materials as the fuser roll surface, there is a tendency for the print substrate to remain tacked to the fuser roll after passing through the nip between the fuser roll and the pressure roll. When this happens, the tacked print substrate does not follow the normal substrate path but rather continues in an arcuate path around the fuser roll, eventually resulting in a paper jam which will require operator involvement to remove the jammed paper before any subsequent imaging cycle can proceed. As a result it has been common practice to ensure that the print substrate is stripped from the fuser roll downstream of the fuser nip. One approach is the use of a plurality of stripper fingers placed in contact with the fuser roll to strip the print substrate from the fuser roll. While satisfactory in many respects, this suffers from difficulties with respect to both fuser roll life and print quality. To ensure an acceptable level of stripping it is frequently necessary to load such a stripper finger against the fuser roll with such a force and at such an attack angle that there is a tendency to peel the silicone rubber off the fuser roll, thereby damaging the roll to such an extent that it can no longer function as a fuser roll.

In addition, media or paper jams after the fuser nip can cause corrugated paper (or accordion jams) to build-up under the stripper fingers and create an upward force, pushing the tips of the fingers into the fuser roll. This of course will also damage the elastomer coating on the fuser roll.

It is known in the prior art to mount flexible stripper fingers rigidly within a machine, so that the fingers are urged against a fuser roll exclusively by the spring force caused by deformation of the fingers. For examples, U.S. Pat. No. 4,063,724 entitled “Image transfer device” discloses image transfer device for transferring an electro-photographically formed image onto a transfer medium comprises grip means for gripping the transfer medium, supporting and moving means for supporting the grip means and moving it cyclically in an endless form, feed means for feeding the transfer medium to be gripped by the grip means, the feed means having a movable paper guide plate disposed adjacent to the path of cyclical movement of the grip means, corona transfer means for transferring the image onto the transfer medium gripped by the grip means, separator means for separating the transfer medium from the grip means, transport means for transporting the separated transfer medium, and control means for causing all of the above-mentioned means to cooperate with one another.

U.S. Pat. No. 6,640,059 entitled “Jam clearance in a post-fuser path in a xerographic printing apparatus” discloses a fuser for xerographic printing, wherein sheets pass through a nip formed by two moving rollers, a substantially enclosed, effectively funnel-shaped path is defined to direct sheets from the nip to a subsequent processing station. When a jam condition occurs in the path, a movable surface defining the path moves to increase a size of the path. The increase in size prevents impaction of subsequent sheets entering the path, and also facilitates manual jam clearance.

U.S. Pat. No. 6,490,428 entitled “Stripper fingers and associated mounts for a fuser in a printing apparatus” that a fuser for xerographic printing, in which stripper fingers remove the print sheet from a fuser roll. Each stripper finger is a thin member, which is urged against the fuser roll with a spring force caused by deformation of the stripper finger against the roll. Each stripper finger is mounted on a mount which is itself springably urged against a stop, so that the spring force of the stripper finger is largely independent of the spring force associated with the mount. The arrangement enables design latitude in choosing spring forces associated with the stripper finger and the mount, and also enables the stripper fingers to be moved away from damaging contact with a mis-stripped sheet.

U.S. Pat. No. 6,782,228 entitled “Intermittent Stripper Fingers And Baffle For Stripping Copy Media From A Heated Fuser Roll” discloses a removal apparatus having a stripper finger structure for separating the lead edge of an imaging media such as plain paper from a heated fuser roll and a stripper baffle for separating the portion of the imaging media beyond the lead edge of the imaging media from the heated fuser roll. The stripper finger structure is supported for movement between a home or standby position and an active position, with the finger tips in constant contact with the heated fuser roll, for effecting separation of the media's lead edge from the heated fuser roll. Likewise, the stripper baffle structure is supported for movement between home or standby positions to its active position where it effects separation of a portion of the imaging media beyond its lead edge.

U.S. Pat. No. 6,785,503 entitled “Stripper fingers and roller assembly for a fuser in a printing apparatus” a fuser for xerographic printing, in which stripper fingers remove the print sheet from a fuser roll. The stripper finger having a tip for stripping a lead edge of a sheet from said fuser roll. A roller assembly, positioned adjacent to said stripper finger; for engaging said lead edge of a sheet and lifting the sheet from further contact with said tip after said tip of said stripper finger strips said lead edge of said sheet from said fuser roll.

### SUMMARY

According to the present disclosure, there is provided a floating stripper finger assembly includes (a) a first baffle; (b) a second baffle, including a slot and a first anchor, and being spaced from, and with, the first baffle defining a media path therebetween; (c ) a stripper finger device having (i) a first end including a stripping tip for stripping media off of a media carrying member, (ii) a second end opposite the first end, (iii) a second anchor, and (iv) a trunnion for mounting movably within the slot in the second baffle; and (d) a resilient member connecting the first anchor to the second anchor for enabling the stripping tip and the trunnion to be movable in a floating manner between a first position and a second position relative to the media path, thereby preventing damage to the media carrying member.

### BRIEF DESCRIPTION OF THE DRAWINGS

In the detailed description below, reference is made to the drawings, in which:

FIG. 1 is a schematic elevational view of an electrostatographic reproduction machine depicting the fast acting fusing method and apparatus of the present disclosure.

FIG. 2 is an elevational view of the floating stripper finger assembly of the present disclosure in a down, no-jam position; and

FIG. 3 is an elevational view of the floating stripper finger assembly of the present disclosure in an up, accordion jam position.

### DETAILED DESCRIPTION

While the present disclosure will be described hereinafter in connection with a preferred embodiment thereof, it should be understood that it is not intended to limit the disclosure to that embodiment. On the contrary, it is intended to cover all alternatives, modifications and equivalents as may be included within the spirit and scope of the disclosure as defined in the appended claims.

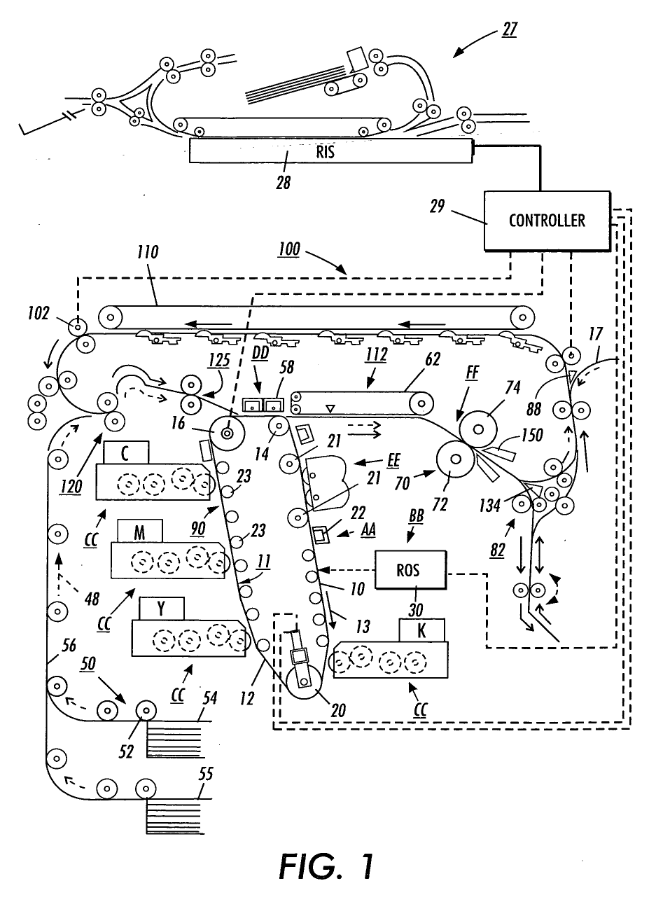

FIG. 1 schematically illustrates an electrostatographic reproduction machine, which generally employs a photoconductive belt 10 mounted on a belt support module 90. Preferably, the photoconductive belt 10 is made from a photoconductive material coated on a ground layer that, in turn, is coated on an anti-curl backing layer. Belt 10 moves in the direction of arrow 13 to advance successive portions sequentially through the various processing stations disposed about the path of movement thereof. Belt 10 is entrained as a closed loop 11 about stripping roll 14, drive roll 16, and idler roll 21. Belt 10 as loop 11 is also entrained about the fast acting fusing apparatus 70 of the present disclosure. As drive roll 16 rotates, it advances belt 10 in the direction of arrow 13.

Initially, a portion of the photoconductive belt surface passes through charging station AA. At charging station AA, a corona-generating device indicated generally by the reference numeral 22 charges the photoconductive belt 10 to a relatively high, substantially uniform potential.

As further shown, the reproduction machine 8 includes a controller or electronic control subsystem (ESS), indicated generally be reference numeral 29 which is preferably a self-contained, dedicated mini-computer having a central processor unit (CPU), electronic storage, and a display or user interface (UI). The ESS 29, with the help of sensors and connections, can read, capture, prepare and process image data and machine status information. As such, it is the main control system for components and other subsystems of machine 8 including the fast acting fusing method and apparatus 70 of the present disclosure.

Still referring to FIG. 1, at an exposure station BB, the controller or electronic subsystem (ESS), 29, receives the image signals from RIS 28 representing the desired output image and processes these signals to convert them to a continuous tone or gray scale rendition of the image which is transmitted to a modulated output generator, for example the raster output scanner (ROS), indicated generally by reference numeral 30. The image signals transmitted to ESS 29 may originate from RIS 28 as described above or from a computer, thereby enabling the electrostatographic reproduction machine 8 to serve as a remotely located printer for one or more computers. Alternatively, the printer may serve as a dedicated printer for a high-speed computer. The signals from ESS 29, corresponding to the continuous tone image desired to be reproduced by the reproduction machine, are transmitted to ROS 30.

ROS 30 includes a laser with rotating polygon mirror blocks. Preferably a nine-facet polygon is used. The ROS 30 illuminates the charged portion on the surface of photoconductive belt 10 at a resolution of about 300 or more pixels per inch. The ROS will expose the photoconductive belt 10 to record an electrostatic latent image thereon corresponding to the continuous tone image received from ESS 29. As an alternative, ROS 30 may employ a linear array of light emitting diodes (LEDs) arranged to illuminate the charged portion of photoconductive belt 10 on a raster-by-raster basis.

After the electrostatic latent image has been recorded on photoconductive surface 12, belt 10 advances the latent image to a development station CC, which includes four developer units containing cmyk color toners, in the form of liquid or dry particles, is electrostatically attracted to the latent image using commonly known techniques. The latent image attracts toner particles from the carrier granules forming a toner powder image thereon. As successive electrostatic latent images are developed, toner particles are depleted from the developer material. A toner particle dispenser, indicated generally by the reference numeral 44, dispenses toner particles into developer housing 46 of developer unit 38.

With continued reference to FIG. 1, after the electrostatic latent image is developed, the toner powder image present on belt 10 advances to transfer station DD. A print sheet 48 is advanced to the transfer station DD, by a sheet feeding apparatus 50. Preferably, sheet-feeding apparatus 50 includes a feed roll 52 contacting the uppermost sheet of stack 54. Feed roll 52 rotates to advance the uppermost sheet from stack 54 to vertical transport 56. Vertical transport 56 directs the advancing sheet 48 of support material into registration transport 57 past image transfer station DD to receive an image from photoreceptor belt 10 in a timed sequence so that the toner powder image formed thereon contacts the advancing sheet 48 at transfer station DD. Transfer station DD includes a corona-generating device 58, which sprays ions onto the backside of sheet 48. This attracts the toner powder image from photoconductive surface 12 to sheet 48. After transfer, sheet 48 continues to move in the direction of arrow 60 by way of belt transport 62, which advances sheet 48 to fusing station FF.

Fusing station FF includes a fuser assembly indicated generally by the reference numeral 70 that permanently affixes the transferred toner power image to the copy sheet. Preferably, fuser assembly 70 includes a heated fuser roller 72 and a pressure roller 74 with the powder image on the copy sheet contacting fuser roller 72. The pressure roller is crammed against the fuser roller to provide the necessary pressure to fix the toner powder image to the copy sheet. The fuser roll may be internally heated as by a quartz lamp (not shown). As further shown, for stripping copy sheets from the fuser roll, the fusing apparatus 70 includes the floating stripper finger assembly 150 of the present disclosure (to be described in detail below).

After passing through the fusing apparatus 70, a gate either allows the sheet to move directly via output 17 to a finisher or stacker, or deflects the sheet into the duplex path 100, specifically, first into single sheet inverter 82 here. That is, if the second sheet is either a simplex sheet, or a completed duplexed sheet having both side one and side two images formed thereon, the sheet will be conveyed via gate 88 directly to output 17. However, if the sheet is being duplexed and is then only printed with a side one image, the gate 88 will be positioned to deflect that sheet into the inverter 82 and into the duplex loop path 100, where that sheet will be inverted and then fed to acceleration nip 102 and belt transports 110, for recirculation back through transfer station DD and fuser 70 for receiving and permanently fixing the side two image to the backside of that duplex sheet, before it exits via exit path 17.

After the print sheet is separated from photoconductive surface 12 of belt 10, the residual toner/developer and paper fiber particles adhering to photoconductive surface 12 are removed therefrom at cleaning station EE. Cleaning station EE includes a rotatably mounted fibrous brush in contact with photoconductive surface 12 to disturb and remove paper fibers and a cleaning blade to remove the non-transferred toner particles. The blade may be configured in either a wiper or doctor position depending on the application. Subsequent to cleaning, a discharge lamp (not shown) floods photoconductive surface 12 with light to dissipate any residual electrostatic charge remaining thereon prior to the charging thereof for the next successive imaging cycle.

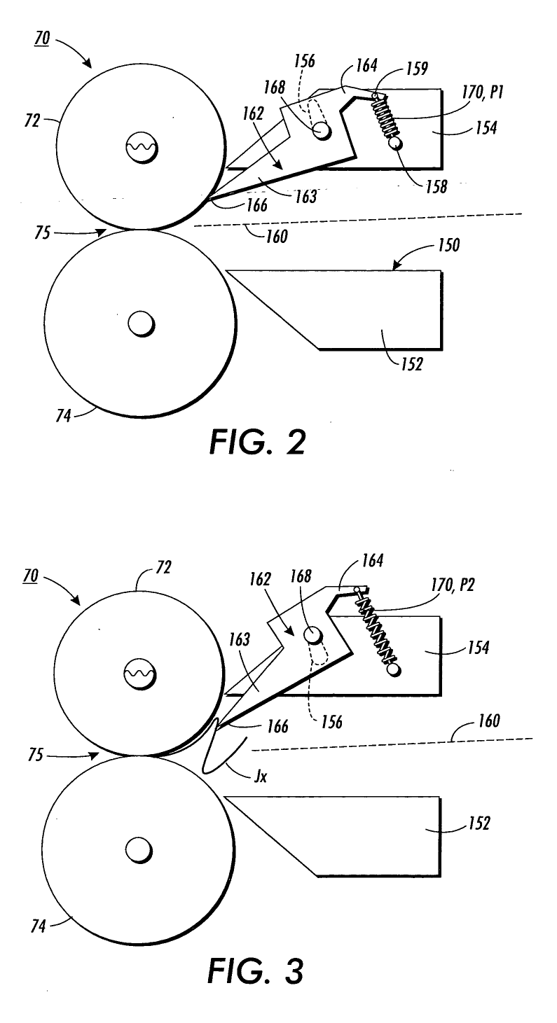

Referring now to FIGS. 1-3, details of the floating stripper finger assembly—of the present disclosure are illustrated. As shown, the fusing apparatus 70 includes a first fusing member such as the fuser roller 72, a second fusing member such as the pressure roller 74 forming a fusing nip 75 with the first member 72, and the floating stripper finger assembly 150 of the present disclosure. The floating stripper finger assembly 150 includes (a) a first baffle 152; (b) a second baffle 154 that includes a slot 156 and a first anchor or attaching means 158. The second baffle 154 is spaced from, and with, the first baffle to define a media path 160 therebetween. The floating stripper finger assembly also includes (c ) a stripper finger device 162 having (i) a first end 163 that includes a stripping tip 166 for stripping media off of a media carrying member such as the fuser roller 72, (ii) a second end 164 opposite the first end 163, (iii) a second anchor or attaching means 159, and (iv) a trunnion 168 for mounting movably within the slot 156 in the second baffle. The floating stripper finger assembly further includes (d) a resilient means or member 170 such as a tension spring, connecting the first anchor 158 to the second anchor 159 for enabling the stripping tip 166 and the trunnion 168 to be movable in a floating manner between a first position P1 and a second position P2 relative to the media path 160, thereby preventing damage to the media carrying member 72.

The floating stripper finger assembly 150 of the present disclosure includes a trunnion 168 sliding in a slot 156 formed in the one of the fuser nip exit guide baffles 152, 154. This arrangement redirects the forces from an accordion paper jam Jx away from the surface of the fuser roll 72. The slot 156 thus allows vertical movement or floating of the finger pivot 156, 168 and any impact from the paper jam Jx is absorbed by the resilient member or extension spring 170, which also provides normal force to the stripping finger device 162 for stripping paper from the fuser roll. The locations or positioning of the spring anchors 158, 159 are such that as the spring 170 extends the lever arm to the pivot 156, 168 is reduced, thereby minimizing any increase in normal force.

As is well known in the art, and shown for example in commonly assigned U.S. Pat. No. 6,785,503, relevant parts of which are incorporated herein by reference, the floating stripper finger assembly 150 of the present disclosure typically will be replicated so as to span the fusing nip 75, and so would normally include a plurality of the stripper finger devices 162 and associated plurality of the resilient members 170. The media path 160 usually lies in a first plane that is horizontal, and the slot 156 in accordance with the present disclosure will extend in a second plane that is generally orthogonal (vertical) to the first plane. As pointed out above, the resilient member comprises a tension spring, and the trunnion 168 is located between the stripping tip 166 and the second end 164 of the stripping finger device 162. According to an aspect of the present disclosure, movement of the stripping tip 166 in a first direction directly results in responsive movement of the trunnion 168, and responsive movement of the resilient member in a second and opposite direction.

As can be seen, there has been provided a floating stripper finger assembly includes (a) a first baffle; (b) a second baffle, including a slot and a first anchor, and being spaced from, and with, the first baffle defining a media path therebetween; (c) a stripper finger device having (i) a first end including a stripping tip for stripping media off of a media carrying member, (ii) a second end opposite the first end, (iii) a second anchor, and (iv) a trunnion for mounting movably within the slot in the second baffle; and (d) a resilient member connecting the first anchor to the second anchor for enabling the stripping tip and the trunnion to be movable in a floating manner between a first position and a second position relative to the media path, thereby preventing damage to the media carrying member.

While the disclosure has been described with reference to the structure disclosed, it is not confined to the details set forth, but is intended to cover such modifications or changes as may come within the scope of the following claims

What is claimed is:

1. A floating stripper finger assembly comprising:
(a) a first baffle;
(b) a second baffle, spaced from and with said first baffle, defining a media path therebetween, said second baffle including a slot and a first attaching means;
(c) a stripper finger device having (i) a first end including a stripping tip for stripping media off of a media carrying member, (ii) a second end opposite said first end, (iii) a second attaching means, and (iv) a trunnion for mounting movably within said slot in said second baffle; and
(d) a resilient member connecting said first attaching means to said second attaching means for enabling said stripping tip and said trunnion to be movable in a floating manner between a first position and a second position relative to said media path, thereby preventing damage to the media carrying member.

2. The floating stripper finger assembly of claim 1, including a plurality of said stripper finger devices and a plurality of said resilient means.

3. The floating stripper finger assembly of claim 1, wherein said media path lies in a first plane and said slot extends in a second plane generally orthogonally to said first plane.

4. The floating stripper finger assembly of claim 1, wherein said resilient means comprise a tension spring.

5. The floating stripper finger assembly of claim 1, wherein said trunnion is located between said stripping tip and said second end.

6. The floating stripper finger assembly of claim 1, wherein said media path is generally horizontal and said slot in said second baffle extends in a generally vertical direction.

7. The floating stripper finger assembly of claim 1, wherein movement of said stripping tip in a first direction directly results in responsive movement of said trunnion, and responsive movement of said resilient means in a second and opposite direction.

8. A fusing apparatus useful in printing, comprising:
a fuser roll;
a pressure roll forming a fusing nip with said fuser roll; and
a floating stripper finger assembly mounted adjacent an exit side of said fusing nip, said floating stripper finger assembly including (a) a first baffle; (b) a second baffle, spaced from and with said first baffle, defining a media path therebetween, said second baffle including a slot and a first attaching means; (c) a stripper finger device having (i) a first end including a stripping tip for stripping media off of a media carrying member, (ii) a second end opposite said first end, (iii) a second attaching means, and (iv) a trunnion for mounting movably within said slot in said second baffle; and (d) a resilient member connecting said first attaching means to said second attaching means for enabling said stripping tip and said trunnion to be movable in a floating manner between a first position and a second position relative to said media path, thereby preventing damage to the media carrying member.

9. The fusing assembly of claim 8, wherein said media path lies in a first plane and said slot extends in a second plane generally orthogonally to said first plane.

10. The fusing assembly of claim 8, wherein said resilient member comprises a tension spring.

11. The fusing assembly of claim 8, wherein said trunnion is located between said stripping tip and said second end.

12. The fusing assembly of claim 8, wherein said media path is generally horizontal and said slot in said second baffle extends in a generally vertical direction.

13. The fusing assembly of claim 8, wherein movement of said stripping tip in a first direction directly results in responsive movement of said trunnion, and responsive movement of said resilient member in a second and opposite direction.

14. An electrostatographic reproduction machine comprising:
(a) a moveable imaging member including and imaging surface;
(b) imaging devices for forming a toner image on said imaging surface;
(c) a transfer station for transferring said toner image from said imaging surface onto an image carrying substrate; and
(d) a fusing apparatus for heating and fusing said toner image on said image carrying substrate, said fusing apparatus including (1) a fuser roll; (2) a pressure roll forming a fusing nip with said fuser roll; and (3) a floating stripper finger assembly mounted adjacent an exit side of said fusing nip, said floating stripper finger assembly including (i) a first baffle; (ii) a second baffle, spaced from and with said first baffle, defining a media path therebetween, said second baffle including a slot and a first attaching means; (iii) a stripper finger device having (w) a first end including a stripping tip for stripping media off of a media carrying member, (x) a second end opposite said first end, (y) a second attaching means, and (z) a trunnion for mounting movably within said slot in said second baffle; and (iv) a resilient member connecting said first attaching means to said second attaching means for enabling said stripping tip and said trunnion to be movable in a floating manner between a first position and a second position relative to said media path, thereby preventing damage to the media carrying member.

15. The electrostatographic reproduction machine of claim 14, wherein said media path lies in a first plane and said slot extends in a second plane generally orthogonally to said first plane.

16. The electrostatographic reproduction machine of claim 14, wherein said resilient member comprise a tension spring.

17. The electrostatographic reproduction machine of claim 14, wherein said trunnion is located between said stripping tip and said second end.

18. The electrostatographic reproduction machine of claim 14, wherein said media path is generally horizontal and said slot in said second baffle extends in a generally vertical direction.

19. The electrostatographic reproduction machine of claim 14, wherein movement of said stripping tip in a first direction directly results in responsive movement of said trunnion, and responsive movement of said resilient means in a second and opposite direction.

20. The electrostatographic reproduction machine of claim 14, including a plurality of the stripper finger devices and a plurality of the resilient members.
